(19) United States
(12) Patent Application Publication
(10) Pub. No.: US 2019/0371544 A1
(43) Pub. Date: Dec. 5, 2019

(54) WATERPROOF BUTTON STRUCTURE OF ELECTRONIC DEVICE

(71) Applicants: SHENZHEN FUTAIHONG PRECISION INDUSTRY CO., LTD., Shenzhen (CN); FIH (HONG KONG) LIMITED, Kowloon (HK)

(72) Inventors: CHANG-HAI GU, Shenzhen (CN); PAN HU, Shenzhen (CN); JIN-GANG ZHOU, Shenzhen (CN); HAN-WU LI, Shenzhen (CN)

(21) Appl. No.: 16/160,997

(22) Filed: Oct. 15, 2018

(30) Foreign Application Priority Data
Jun. 5, 2018 (CN) 201810567447.5

(51) Int. Cl. H01H 13/86; H04M 1/02

(52) U.S. Cl. CPC H01H 13/86; H01H 13/807; H04M 1/026

(57) ABSTRACT

A power supply includes a main body having a coupling face and a handlebar. The coupling face includes a first end and a second end forming a power socket. The handlebar includes a first beam coupled to the first end and a second beam. The first beam extends a tab outwardly. The handlebar defines a window configured to expose the power socket. The handlebar is transitionable between: (i) a first configuration in which the second beam couples the second end, the window corresponds and exposes the power socket, the tab extends toward a first direction, and (ii) a second configuration in which the second beam is remote from the second end, the window is remote from the power socket, and the tab extends toward a second direction different from the first direction. A method for removing the power supply from a case of an electronic device is also provided.

### FIELD

The subject matter herein generally relates to electronic devices, and more particularly to a waterproof button structure for an electronic device.

### BACKGROUND

Generally, button structures of an electronic device may not completely prevent water and/or dust from entering the electronic device through the button structure.

Therefore, there is room for improvement within the art.

### BRIEF DESCRIPTION OF THE DRAWINGS

Implementations of the present disclosure will now be described, by way of example only, with reference to the attached figures.

FIG. 1 is an exploded, isometric view of an embodiment of a button structure in accordance with the present disclosure.

FIG. 2 is an exploded, isometric view of an electronic device and the button structure in FIG. 1.

FIG. 3 is a cross-sectional view of the button structure.

FIG. 4 is a partial cutaway view of the button structure applied in the electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

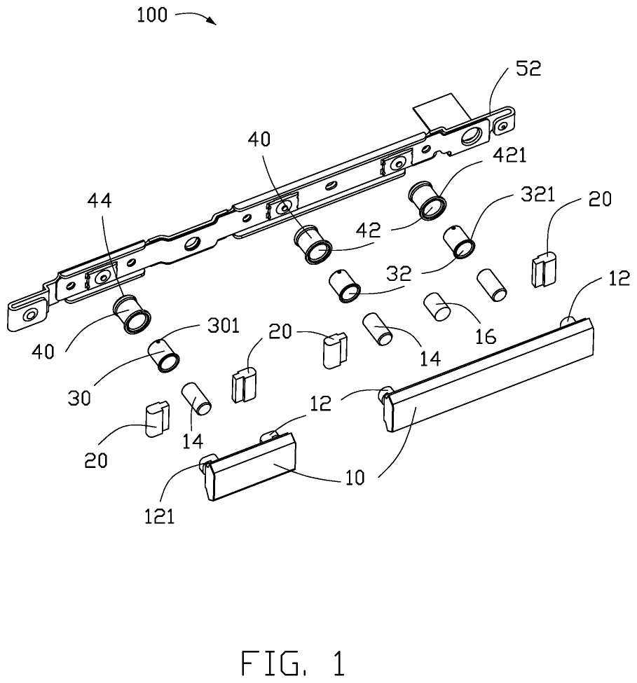

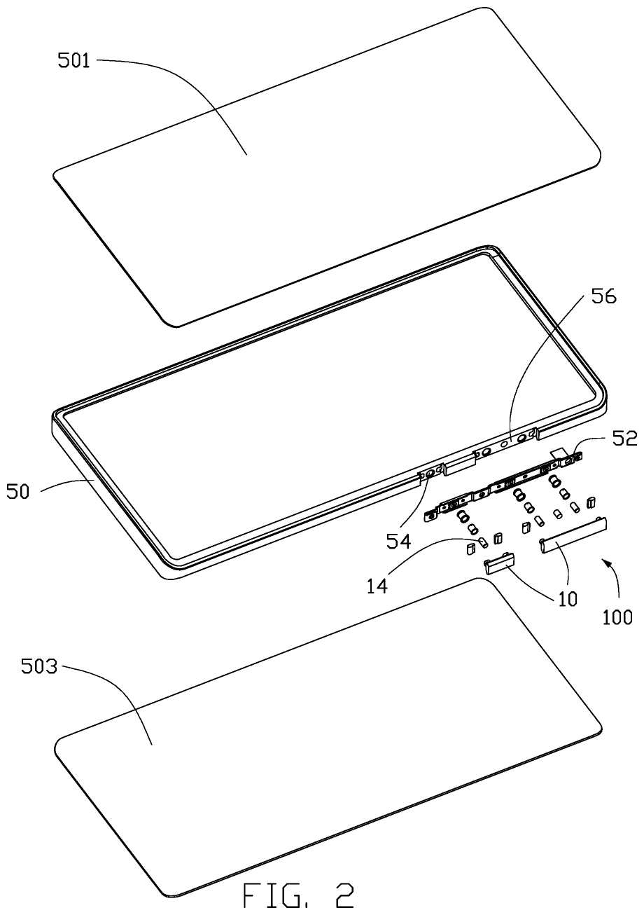

FIG. 1 illustrates an embodiment of a waterproof button structure 100 (hereinafter “the structure 100”). The structure 100 includes a button body 10, a pair of fixing blocks 20, a fixing ring 30, and a waterproofing ring 40. The button body 10 includes a pair of guide columns 12 and at least one button tip 14. Each guide column 12 is located at a corresponding end portion of the button body 10. The guide column 12 latches with the fixing block 20 to install the button body 10 to an outer shell 50 of an electronic device (shown in FIG. 2). The fixing ring 30 is sleeved over the button tip 14, and the waterproofing ring 40 is sleeved over the fixing ring 30. Thus, the button tip 14 is sleeved by the fixing ring 30 and the waterproofing ring 40 in sequence. The button body 10 is positioned by the button tip 14 sleeved by the fixing ring 30 and the waterproofing ring 40 to operate on circuitry of the electronic device. In at least one embodiment, the structure 100 includes two button bodies 10 arranged in a row. One of the button bodies 10 includes one button tip 14, and the other button body 10 includes two button tips 14. Each button tip 14 has sleeved thereon the fixing ring 30 and the waterproofing ring 40 in sequence.

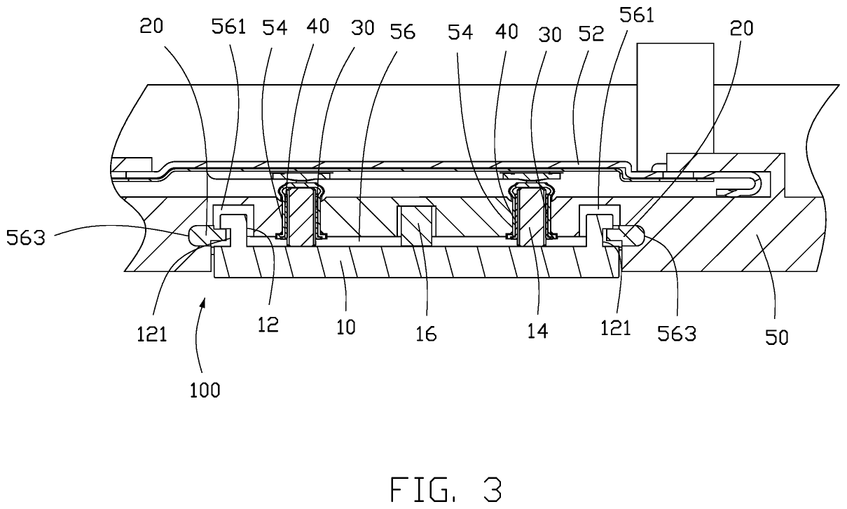

Referring to FIG. 2, the structure 100 is applied on the outer shell 50 of the electronic device. The electronic device illustrated is a mobile phone. The outer shell 50 includes a front cover 501 and a back cover 503. The front cover 501 and the back cover 503 are assembled to the outer shell 50 to form the mobile phone. In detail, the outer cover 50 includes a circuit board 52 therein, and the structure 100 is positioned in front of the circuit board 52 on the outer shell 50. The button body 10 operates functions of the circuit board 52 through the button tip 14 and the waterproofing ring 40, and the button tip 14 is positioned in front of the circuit board 52 through a button hole 54 defined in the outer shell 50. In detail, the button tip 14 is positioned within the button hole 54 between the button body 10 and the outer shell 50. The fixing ring 30 and the waterproofing ring 40 are positioned between the button hole 54 and the button tip 14. The waterproofing ring 40 provides a waterproof and dustproof function. Two ends of the fixing ring 30 are open ends, so that the fixing ring 30 is directly sleeved over the button tip 14. The waterproofing ring 40 is made of a resilient waterproof material. One end of the waterproofing ring 40 is an open end, and another end of the waterproofing ring 40 is a sealed end. The waterproofing ring 40 includes an open end 42 and a sealed end 44. The waterproofing ring 40 is sleeved over the fixing ring 30 through the open end 42. The sealed end 44 is positioned in front of the circuit board 52 (shown in FIG. 3). Thus, the button body 10 is pressed to drive the button tip 14 to press the sealed end 44 of the waterproofing ring 40 to press the circuit board 52, thereby operating functions of the circuit board 52.

Referring to FIG. 3, the structure 100 is installed in an accommodating groove 56 defined in the outer shell 50. The button hole 54 is defined in a bottom of the accommodating groove 56. The button body 10 contacts the circuit board 52 through the button hole 54. The accommodating groove 56 defines a guide slot 561 in each of two ends thereof. Each guide slot 561 receives a corresponding guide column 12. The accommodating groove 56 defines a scarf slot 563 in each of two inner walls thereof. The fixing block 20 is received in the scarf slot 563 to position the fixing block 20 in front of the guide column 12 within the accommodating groove 56. In at least one embodiment, the guide column 12 defines a groove 121 corresponding to the fixing block 20. The groove 121 is aligned with the fixing block 20, and the fixing block 20 protrudes from a side of the accommodating groove 56 to be received within the groove 121 of the guide column to install the button body 10 within the accommodating groove 56 of the outer shell 50. In other words, the button body 10 fixed on the outer shell 50 is not able to fall off and is held in place by the fixing blocks 20 within the accommodating groove 56 received within the grooves 121 of the guide columns 12. The accommodating groove 56 further includes a resilient member 16 located between the accommodating groove 56 and the button body 10. When the button body 10 is pressed, the resilient member 16 is compressed, and a restoring force of the resilient member 16 restores the button body 10 in position after being pressed. In at least one embodiment, when the button body 10 simultaneously pushes two or more button tips 14, since the button body 10 is relatively elongated, the restoring force of the resilient member 16 increases resiliency of the button body 10. When the button body 10 only pushes one button tip 14 or is not relatively elongated, the resilient member 16 may be omitted, so that a restoring force of the waterproofing ring 40 restores the button body 10 to an original position after being pressed.

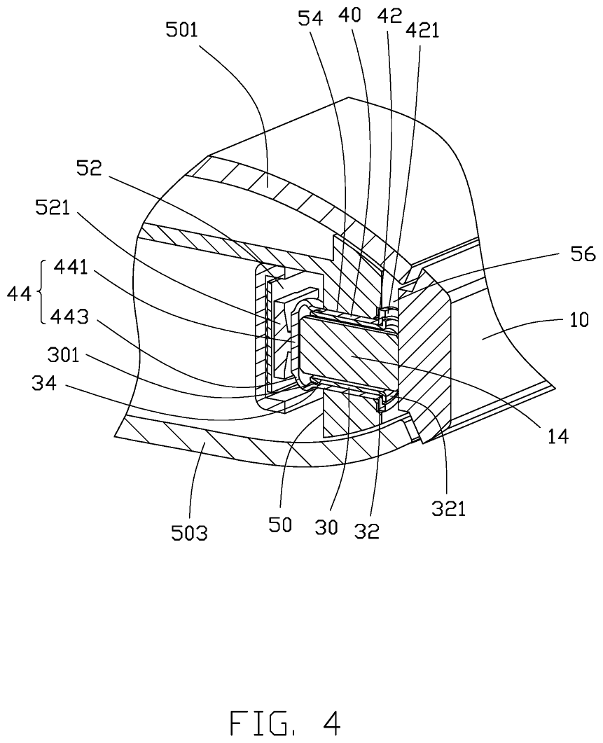

Referring to FIG. 4, the open end 42 of the waterproofing ring 40 includes a first flange 421. An open end 32 of the fixing ring 30 includes a second flange 321. The waterproofing ring 40 sleeved over the fixing ring 30 causes the second flange 321 to be coupled to an inner surface of the first flange 421. The first flange 421 and the second flange 321 are located within the button hole 54 at a side of the button hole 54 facing the button body 10. In detail, the waterproofing ring 40 sleeved over the fixing ring 30, with the first flange 421 coupled to the second flange 321, fixes the waterproofing ring 40 in place. That is, the second flange 321 makes the fixing ring 30 and the waterproofing ring 40 to be assembled together sturdily, and the first flange 421 makes the waterproofing ring 40 sturdy within the button hole 54. The fixing ring 30 further includes a protrusion 301 (shown in FIG. 1). The protrusion 301 is positioned at an opposite open end 34, and the protrusion 301 protrudes from an outer surface of the fixing ring 30. The protrusion 301 and the second flange 321 positioned at two sides of the button hole 54 fixes the fixing ring 30 within the button hole 54.

The sealed end 44 of the waterproofing ring 40 includes a pressing bottom 441 and a resilient portion 443. The pressing bottom 441 is located on a bottom end of the sealed end 44. The resilient portion 443 is located on a lower periphery of the sealed end 44. The resilient portion 443 is coupled to the pressing bottom 441 and a sidewall of the waterproofing ring 40. The pressing bottom 441 is pushed by the button tip 14 to press the circuit board 52, and the resilient portion 443 generates a resilient restoring force when the button tip 14 presses the pressing bottom 441. Thus, the resilient restoring force of the resilient portion 443 maintains a press contact of the button tip 14 on the pressing bottom 441. In detail, the resilient portion 443 is located on the lower periphery of the sealed end 44. When the button tip 14 presses the pressing bottom 441 (the button body 10 is pressed), the resilient portion 443 generates the resilient restoring force. When the button tip 14 stops pressing the pressing bottom 441 (the button body 10 is not pressed), the resilient restoring force of the resilient portion 443 is applied on the button tip 14 to restore the button body 10 to an original position. Thus, the resilient portion 443 of the sealed end 44 of the waterproofing ring 40 makes the button body 10 have resiliency and a high tolerance for deformation, thereby maintaining the waterproofing function of the waterproofing ring 40.

In addition, the button tip 14 is made of hard material, the waterproofing ring 40 is made of soft resilient material, and a thickness of the pressing bottom 441 is greater than a thickness of the sidewall of the waterproofing ring 40. Thus, an abrasion resistance of the pressing bottom 441 is increased to prevent damage of the waterproofing ring 40, thereby increasing a lifespan and a touch accuracy of the waterproofing ring 40. It should be noted that the circuit board 52 within the outer shell 50 includes at least one conductive point 521 positioned in front of the sealed end 44 of the waterproofing ring 40. When the button tip 14 presses the conductive point 521 through the sealed end 44, a control circuit of the circuit board 52 is conducted. In at least one embodiment, the circuit board 52 is a flexible circuit board located on an inner side of the outer shell 50. The flexible circuit board is positioned in front of the button body installed on the outer shell 50 through the button hole 54. Thus, the waterproofing ring 40 with the sealed end 44 received within the button hole 54 increases a waterproof and dustproof function.

The sealed end 44 of the waterproofing ring 40 sleeved within the button hole 54, in addition to the resilient portion 443 of the sealed end 44 increasing a resilient area of the waterproofing ring 40, provide precision waterproof and dustproof functionality of the structure 100.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A waterproof button structure comprising:
a button body comprising a guide column and a button tip;
a fixing block;
a fixing ring; and
a waterproofing ring having two ends;
wherein the fixing block latches with the guide column to install the button body to an outer shell of an electronic device;
wherein the button tip passes through a button hole defined in the outer shell to be positioned opposite to a circuit board within the outer shell;
wherein the fixing ring is sleeved over the button tip;
wherein one end of the waterproofing ring is an open end and one end of the waterproofing ring is a sealed end;
wherein the waterproofing ring is sleeved over the fixing ring through the open end.

2. The waterproof button structure of claim 1, wherein an accommodating groove is defined in an outer surface of the outer shell; the button body is to be received within the accommodating groove; the button hole is defined within the accommodating groove; at least one guide slot is defined within the accommodating groove; the at least one guide slot receives the guide column; a scarf slot is defined in each of two inner sides of the accommodating groove; the fixing block is to be received in the scarf slots to position the fixing block within the accommodating groove opposite to the guide column.

3. The waterproof button structure of claim 2, wherein a groove is defined in the guide column; the groove is aligned with the fixing block, and the fixing block protrudes from a side of the accommodating groove to be received within the groove of the guide column.

4. The waterproof button structure of claim 2, wherein a resilient member is received within the accommodating groove and located between the accommodating groove and the button body; the resilient member resiliently restores the button body when the button body is pressed in the accommodating groove.

5. The waterproof button structure of claim 1, wherein the open end of the waterproofing ring comprises a first flange; one open end of the fixing ring comprises a second flange; the waterproofing ring sleeved over the fixing ring causes the second flange to be coupled to an inner surface of the first flange.

6. The waterproof button structure of claim 5, wherein the first flange and the second flange are located within the button hole at a side of the button hole facing the button body.

7. The waterproof button structure of claim 6, wherein the fixing ring comprises at least one protrusion; the protrusion is located at the open end of the fixing ring away from the second flange; the protrusion is located to an outer surface of the fixing ring; the protrusion and the second flange are respectively located at opposite sides of the button hole to fix the fixing ring within the button hole.

8. The waterproof button structure of claim 1, wherein the sealed end of the waterproofing ring comprises a pressing bottom and a resilient portion; the pressing bottom is located on a bottom end of the sealed end; the resilient portion is located on a lower periphery of the sealed end.

9. The waterproof button structure of claim 8, wherein the resilient portion is coupled to the pressing bottom and a sidewall of the waterproofing ring; a resilient restoring force of the resilient portion maintains a press contact of the button tip on the pressing bottom.

10. The waterproof button structure of claim 9, wherein the button tip is made of hard material.

11. The waterproof button structure of claim 10, wherein the waterproofing ring is made of resilient material.

12. The waterproof button structure of claim 11, wherein a thickness of the pressing bottom is greater than a thickness of the sidewall of the waterproofing ring.
